(19) United States
(12) Patent Application Publication
(10) Pub. No.: US 2025/0273984 A1
(43) Pub. Date: Aug. 28, 2025

(54) ADAPTER PERFORMING OPERATION TO SAVE POWER, ELECTRONIC DEVICE, AND OPERATION METHOD THEREFOR

(71) Applicant: Samsung Electronics Co., Ltd., Suwon-si (KR)

(72) Inventors: Sangwook LEE, Suwon-si (KR); Kyungmin LEE, Suwon-si (KR); Youngho RYU, Suwon-si (KR)

(21) Appl. No.: 19/208,256

(22) Filed: May 14, 2025

Related U.S. Application Data
(63) Continuation of application No. PCT/KR2023/015846, filed on Oct. 13, 2023.

(30) Foreign Application Priority Data
Dec. 13, 2022 (KR) 10-2022-0174141

(51) Int. Cl. H02J 9/00; H02J 13/00

(52) U.S. Cl. CPC H02J 9/005; H02J 13/00022; H02J 13/0005

(57) ABSTRACT

An electronic device may comprise: a battery; a first terminal for connection to a wall power source; a second terminal for connection to a home appliance; a conversion circuit configured to convert alternating current power provided from the wall power source through the first terminal into direct current power and provide same through the second terminal; a power supply configured to provide power for operation of the conversion circuit using power provided from the battery; and a communication circuit configured to operate using the power provided from the battery. The communication circuit may be configured to periodically broadcast a beacon signal using the power provided from the battery while the conversion circuit is turned off. When the conversion circuit is turned off, the electronic device does not receive the alternating current power from the wall power source through the first terminal, and the direct current power may not be provided to the home appliance through the second terminal. The communication circuit may be configured to provide, to the conversion circuit, a signal that causes the conversion circuit to be turned on, based on a response signal in response to the beacon signal being received from an external electronic device.

### CROSS-REFERENCE TO RELATED APPLICATIONS

This application is a continuation of International Application No. PCT/KR2023/015846 designating the United States, filed on Oct. 13, 2023, in the Korean Intellectual Property Receiving Office and claiming priority to Korean Patent Application No. 10-2022-0174141, filed on Dec. 13, 2022, in the Korean Intellectual Property Office, the disclosures of each of which are incorporated by reference herein in their entireties.

### BACKGROUND

### Field

The disclosure relates to an adapter for performing an operation of saving power, an electronic device, and a method of operating the same.

### Description of Related Art

Home appliances which can be remotely controlled have been actively introduced. For example, such home appliances may be controlled based on signals from an IR-based remote control. For example, technology for remotely controlling home appliances through smartphones has been disclosed. For example, smartphones may provide communication signals according to Bluetooth (or Bluetooth low energy (BLE)) communication or communication signals according to IEEE 802.11-based communication (or called Wi-Fi). For example, a user may control home appliances by controlling an IR-based remote controller or a smartphone.

As described above, home appliances may be controlled based on communication signals from electronic devices for remote control. Functions of the home appliances which can be controlled may include turning-on of the home appliances. For example, the user may control the electronic device to turn on the home appliance while main functions (for example, outputting audiovisual content in the case of TV) of the home appliance is deactivated. The electronic device may transmit a communication signal that causes turning-on of the home appliance to the home appliance according to the control of the user. The home appliance may perform an operation for the turning-on, based on the received communication signal. Meanwhile, in order to receive a communication signal for remote control even in a turned off state, some components of the home appliance, for example, a communication circuit, a processing circuit for processing a communication signal received through the communication circuit, and a conversion circuit (for example, a converter) for providing direct current power to the processing circuit and the communication circuit may need to maintain a turned on state.

### SUMMARY

According to an example embodiment, an electronic device may include: a battery, a first terminal configured to be connected to a wall power source, a second terminal configured to be connected to a home appliance, a conversion circuit configured to convert alternating current power, provided from the wall power source through the first terminal, into direct current power and provide the direct current power through the second terminal, a power supply configured to provide power for an operation of the conversion circuit using power provided from the battery, and a communication circuit configured to operate using the power provided from the battery. The communication circuit may be configured to periodically broadcast a beacon signal by using the power provided from the battery in a state in which the conversion circuit is turned off. In the state in which the conversion circuit is turned off, the electronic device may not receive the alternating current power from the wall power source through the first terminal and the direct current power may not be provided to the home appliance through the second terminal. The communication circuit may be configured to provide a signal causing the conversion circuit to be turned on to the conversion circuit, based on a response signal corresponding to the beacon signal being received from an external electronic device.

According to an example embodiment, a method of operating an electronic device including a battery, a first terminal configured to be connected to a wall power source, a second terminal configured to be connected to a home appliance, a conversion circuit configured to convert alternating current power, provided from the wall power source through the first terminal, into direct current power and provide the direct current power through the second terminal, a power supply configured to provide power for an operation of the conversion circuit using power provided from the battery, and a communication circuit configured to operate using the power provided from the battery may include: by the communication circuit, periodically broadcasting a beacon signal using the power provided from the battery in a state in which the conversion circuit is turned off. In the state in which the conversion circuit is turned off, the electronic device may not receive the alternating current power from the wall power source through the first terminal and the direct current power may not be provided to the home appliance through the second terminal The method of operating the electronic device may include: by the communication circuit, providing a signal causing the conversion circuit to be turned on to the conversion circuit, based on a response signal to the beacon signal being received from the external electronic device.

According to an example embodiment, the electronic device may include: a battery, a terminal configured to be connected to a wall power source, a conversion circuit configured to convert alternating current power, provided from the wall power source through the terminal, into direct current power, a distribution circuit configured to distribute the direct current power, a controller, comprising circuitry, connected to the distribution circuit, and a communication circuit configured to operate using power provided from the battery. The communication circuit may be configured to periodically broadcast a beacon signal using power provided from the battery in a state in which a main function of the electronic device is turned off. In the state in which the main function of the electronic device is turned off, the electronic device may not receive the alternating current power from the wall power source through the terminal and power may not be provided to the conversion circuit, the distribution circuit, and the controller. The communication circuit may be configured to provide a signal causing the conversion circuit to be turned on to the conversion circuit, based on a response signal corresponding to the beacon signal being received from an external electronic device.

According to an example embodiment, a method of operating an electronic device including a battery, a terminal configured to be connected to a wall power source, a conversion circuit configured to convert alternating current power, provided from the wall power source through the terminal, into direct current power, a distribution circuit configured to distribute the direct current power, a controller connected to the distribution circuit, and a communication circuit configured to operate using power provided from the battery may include: by the communication circuit, periodically broadcasting a beacon signal using power provided from the battery in a state in which a main function of the electronic device is turned off. In the state in which the main function of the electronic device is turned off, the electronic device may not receive the alternating current power from the wall power source through the terminal and power may not be provided to the conversion circuit, the distribution circuit, and the controller. The method of operating the electronic device may include: by the communication circuit, providing a signal causing the conversion circuit to be turned on to the conversion circuit, based on a response signal corresponding to the beacon signal being received from an external electronic device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a diagram illustrating an example operation and power consumption of a home appliance according to a comparative example for comparison with an embodiment;

FIGS. 1B and 1C are block diagrams illustrating example configurations of a home appliance according to a comparative example to be compared with an embodiment;

FIG. 2A is a diagram illustrating an example electronic device according to an embodiment;

FIG. 2B is a block diagram illustrating an example configuration of an electronic device according to an embodiment;

FIG. 2C is a diagram illustrating an example electronic device according to an embodiment;

FIG. 2D is a block diagram illustrating an example configuration of an electronic device according to an embodiment;

FIG. 3A is a diagram illustrating an example operation of an electronic device while a main function of a home appliance is turned off according to an embodiment;

FIGS. 3B and 3C are diagrams illustrating example operations of an electronic device while and/or after a home appliance is turned on according to an embodiment;

FIG. 3D is a graph illustrating power consumed by a home appliance according to an embodiment;

FIG. 3E is a graph illustrating power consumed by a home appliance supporting an idle state according to an embodiment;

FIG. 4 is a signal flow diagram illustrating an example method of operating an electronic device, a home appliance, and an external electronic device according to an embodiment;

FIG. 5A is a flowchart illustrating an example method of operating an external electronic device according to an embodiment;

FIG. 5B is a flowchart illustrating an example method of operating an external electronic device according to an embodiment;

FIG. 5C is a diagram illustrating an example UI provided by an external electronic device according to an embodiment;

FIG. 6 is a flowchart illustrating an example method of operating an external electronic device according to an embodiment;

FIGS. 7A, 7B, and 7C are block diagrams illustrating example configurations of an electronic device according to an embodiment;

FIG. 8A is a signal flow diagram illustrating an example method of operating an electronic device and an external electronic device according to an embodiment;

FIG. 8B is a signal flow diagram illustrating an example method of operating an electronic device and an external electronic device according to an embodiment;

FIG. 8C is a diagram illustrating switching between states of an electronic device according to an embodiment; and

FIG. 9 is a flowchart illustrating an example method of operating an external electronic device according to an embodiment.

### DETAILED DESCRIPTION

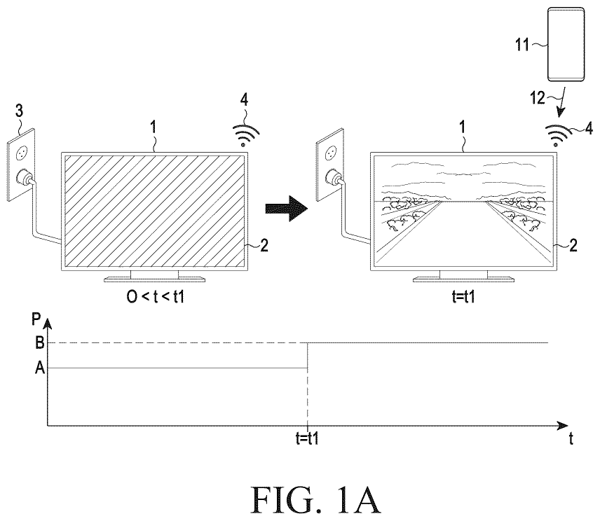

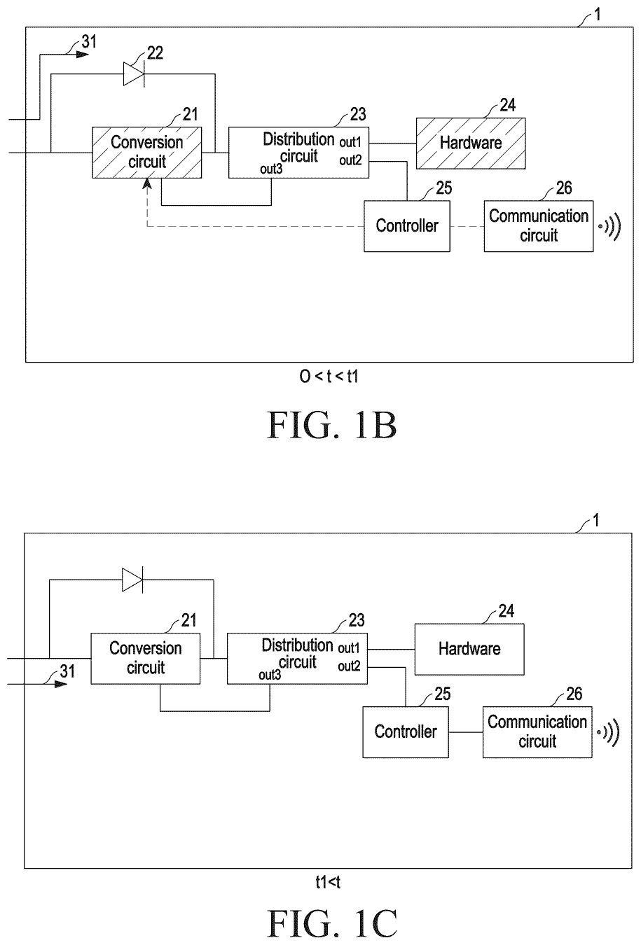

FIG. 1A is a diagram illustrating an example operation and power consumption of a home appliance according to a comparative example for comparison with an embodiment. At least some of the operations performed according to the comparative example of FIG. 1A or another comparative example of the disclosure may be performed by at least one embodiment of the disclosure.

Referring to FIG. 1A, a home appliance 1 may be implemented as TV, but is only an example and there no limitation in an implementation type of the home appliance 1. The home appliance 1 may include hardware, for example, a display module 2 for a main function (for example, providing audiovisual content in the case of TV). The home appliance 1 may maintain a “turned-off state” before a time point t1. The “turned-off state” in the comparative example of FIG. 1A may be a turned-off state of hardware (for example, the display module 2) for the main function of the home appliance 1. For example, the display module (e.g., including a display) 2 may also maintain the turned-off state, but the communication circuit (not shown) included in the home appliance 1 may maintain the turned-on state. As the communication circuit (not shown) maintains the turned-on state, a communication function 4 may be activated, and the communication circuit (not shown) may receive a communication signal from the outside. For example, the communication circuit (not shown) may monitor whether the communication signal received from the outside and needs to persistently (or semi-persistently) maintain the turned-on state according thereto. Further, a processing circuit (for example, a processor) for processing the communication signal received from the communication circuit (not shown) and/or a conversion circuit (for example, a converter) for converting alternating current power from a wall power source to direct current power need to persistently (or semi-persistently) maintain the turned-on state. A first terminal 3 of the home appliance 1 may be connected to the wall power source. In order to maintain the turned-on state of the communication circuit (not shown), power may be provided from the wall power source to the home appliance 1 through the first terminal 3 even in the state where the main function of the home appliance 1 is turned off. In FIG. 1A, power consumption by the home appliance 1 before the time point t1 is illustrated. For example, referring to FIG. 1A, power consumption (P) by the home appliance 1 in the state where the main function is turned off may have a value of “A”. The power consumption (P) is expressed as a constant value of “A”, but is simply for convenience of description, and those skilled in the art can understand that the power consumption (P) may not have the constant value.

At the time point t1, the home appliance 1 may receive a communication signal 12 from an external electronic device 11. The home appliance 1 may turn on hardware for the main function, for example, the display module 2, based on the communication signal 12 being received. Accordingly, the power consumption (P) by the home appliance 1 after the time point t1 may increase from “A” to “B”. As described above, the home appliance 1 may turn on hardware associated with remote control, for example, the communication circuit (not shown) and turn off the remaining hardware, for example, the display module 2 before the communication signal 12 is received, and thus power consumption may remain in a relatively small value (for example, A). However, in the comparative example, although the power consumption is a value smaller than power consumption (for example, B) in a completely turned-on state, power consumption (for example, A) for remote control may be continuously consumed, so that continuous power provision from the wall power source may be required. The electronic device according to various embodiments of the disclosure may provide a remote control function by using power consumption relatively smaller than the power consumption (A) before the time point t1 in the comparative example without receiving power from the wall power source in the state where the main function is turned off, which will be described below in more detail. Hereinafter, the generation of power consumption by the comparative example is described in greater detail with reference to FIGS. 1B and 1C.

FIGS. 1B and 1C are block diagrams illustrating example configurations of a home appliance according to a comparative example to be compared with an embodiment.

It is assumed that the main function of the home appliance 1 in FIG. 1B is turned off. For example, when the home appliance 1 is implemented as TV, the display module 2 may be turned off, but it is only an example and there is no limitation in the type of hardware and/or the type of the home appliance 1 turned off in the state where the main function is turned off. According to the comparative example, the home appliance 1 may include a conversion circuit 21, a distribution circuit 23, hardware 24 for the main function, a controller 25, and a communication circuit 26. A diode 22 for bypass may be connected to both ends of the conversion circuit 21. The home appliance 1 may include the terminal 3 as described in FIG. 1A, and accordingly power 31 may be provided from the wall power source to the home appliance 1 through the terminal 3. When the conversion circuit 21 is turned off, power may be provided through the diode 22. When the conversion circuit 21 is turned on, a potential difference may be generated between both ends of the conversion circuit 21, and thus the power may be provided through the conversion circuit 21 rather than the diode 22.

The conversion circuit 21 may convert input alternating current power to direct current power and provide the converted power. The distribution circuit 23 may provide the input direct alternating power to at least one output terminal (for example, out1, out2, and out3 of FIG. 1B). The hardware 24 for the main function may include, for example, at least one hardware for the main function of the home appliance 1. For example, when the home appliance 1 is implemented as TV, the hardware 24 for the main function may include a display module for displaying an image, a speaker for outputting a sound, and the like, but there is no limitation. The controller 25 may control the operation of the elements included in the home appliance 1. The controller 25 may include various processing circuitry and may, for example, be implemented as, for example, a micro controlling unit (MCU), a field programmable gate array (FPGA), an application-specific integrated circuit (ASIC), or the like, and those skilled in the art can understand there is no limitation if the controller is a mean for processing instructions (or programs or applications). The communication circuit 26 may support, for example, short-range communication (for example, Bluetooth communication or Wi-Fi communication) and there is no limitation in the type of short-range communication. The communication circuit 26 may receive a communication signal from the external electronic device 11 and/or transmit a communication signal through, for example, short-range communication (or through a relay device). The communication circuit 26 may support, for example, IR-based communication and receive an IR-based signal from, for example, a remote controller.

In the state where the main function is turned off, some elements of the home appliance 1 may be turned off and the remaining elements may be turned on. For example, in the state where the main function is turned off, the conversion circuit 21 and the hardware 24 for the main function may be turned off. In the state where the main function is turned off, the distribution circuit 23, the controller 25, and the communication circuit 26 may be turned on. The communication circuit 26 may need to be turned on persistently (or semi-persistently) in order to receive a communication signal for turning on the home application 1 from the external electronic device 11. For example, in the state where the main function is turned off, the user may control the external electronic device 11 such as a smartphone or a remote controller (for example, make touch through a UI displayed on the smartphone and/or process a physical key included in the remote controller) in order to turn on the home appliance 1. The external electronic device 11 may transmit a communication signal that causes turning on of the home appliance 1. Since tuning on based on remote control is possible only when the communication signal that causes turning on is received, the communication circuit 26 of the home appliance 1 may need to be turned on persistently (or semi-persistently). Further, in order to process the communication signal (or information on a decoded communication signal) provided from the communication circuit 26, the controller 25 also needs to be turned on persistently (or semi-persistently). In addition, distribution circuit 23 may need to be turned on persistently (or semi-persistently) to distribute power 31 (or converted power) from the wall power source and provide the power to the controller 25. Referring to FIG. 1B, although it is illustrated that the power 31 is provided to the distribution circuit 23 through a bypass path 22 as the conversion circuit 21 is turned off while the main function of the home appliance 1 is turned off, it is only an example and the bypass path 22 may not be included in the home appliance 1 in which case the conversion circuit 21 also needs to be turned on persistently (or semi-persistently). According to the above description, in order to remotely turn on the home appliance 1, elements for receiving and/or processing the communication signal from the remote external electronic device 11 need to be turned on persistently (or semi-persistently). Accordingly, as described in FIG. 1A, even when the main function is turned off, the home appliance 1 may consume power consumption at a specified level (for example, A but there is no limitation, and may not be a constant value).

Referring to FIG. 1C, the communication circuit 26 may receive a communication signal (for example, a communication signal including information that causes turning on of the home appliance 1). The controller 25 may perform control to turn on the hardware 24 for the main function of the home appliance 1, based on the communication signal (or the information included in the communication signal). For example, the controller 25 may provide driving power (or a driving voltage) to the conversion circuit 21 through an output terminal (out 3) by controlling the distribution circuit 23. The conversion circuit 21 may be turned on, and may convert alternating current power into direct current power and provide the direct current power to the distribution circuit 23. Further, the controller 25 may provide power to the hardware 24 for the main function through the output terminal (out 2) by controlling the distribution circuit 23. Accordingly, the hardware 24 for the main function may receive power for driving and may be turned on. Therefore, the user may receive the main function of the home appliance 1. However, as described above, even in the state where the main function is turned off, some elements of the home appliance 1 (for example, the distribution circuit 23, the controller 25, and/or the communication circuit) need to be turned on for remote control, and accordingly, power consumption by the elements may be generated.

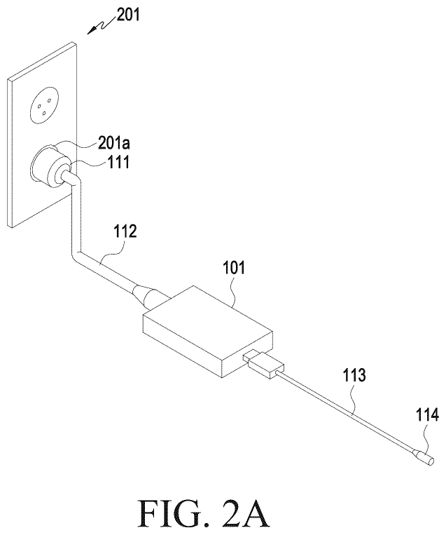

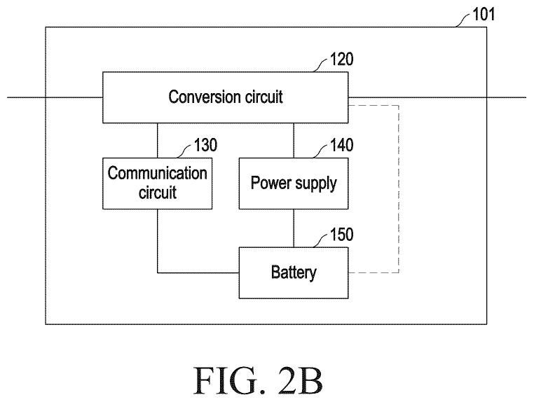

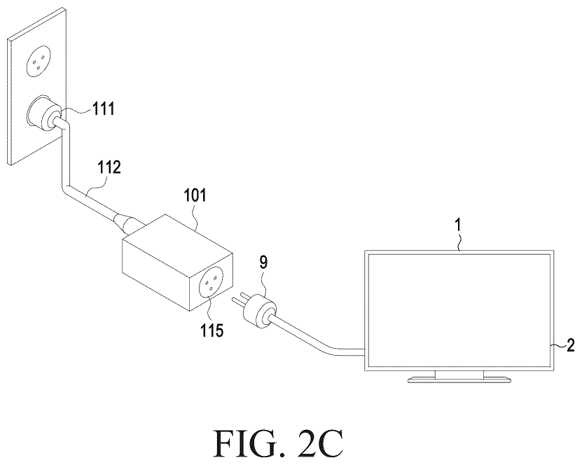

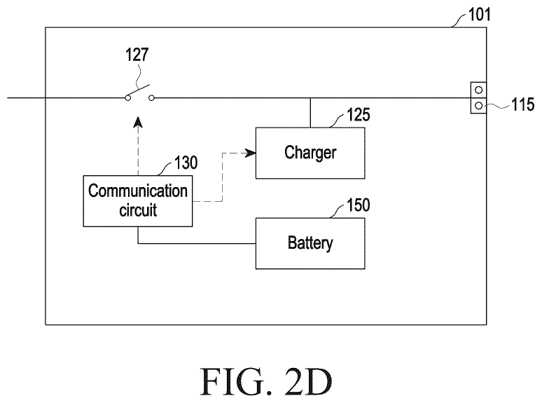

FIG. 2A is a diagram illustrating an example electronic device according to an embodiment. FIG. 2A is described with reference to FIG. 2B. FIG. 2B is a block diagram illustrating an example configuration of an electronic device according to an embodiment.

According to an embodiment, an electronic device 101 may be implemented as an adapter for providing power to the home appliance 1, but it is only an example and there is no limitation, and various implementation forms of the electronic device 101 is described below. The electronic device 101 may include a first terminal 111 to be connected to a wall power source 201. The first terminal 111 may have the form that can be inserted into an outlet 201a of the wall power source 201, but there is no limitation. The electronic device 101 may include an electric wire 112 connected to the first terminal 111 and an electric wire 113 connected to a second terminal 114, but there is no limitation in forms and/or specifications of the electric wires 112 and 113. The second terminal 114 is to be connected to the home appliance 1 and may have the form that can be inserted into a power interface (or terminal) of the home appliance 1, but there is no limitation. Although it has been described that the electronic device 101 includes the first terminal 111, the electric wires 112 and 113, and the second terminal 114, it is only an example, and those skilled in the art may understand that the electronic device 101 can be implemented in the form that can be connected to at least some of the first terminal 111, the electric wires 112 and 113, and the second terminal 114.

Referring to FIG. 2B, the electronic device 101 according to an embodiment may include a conversion circuit 120, a communication circuit 130, a power supply 140, and/or a battery 150. The conversion circuit 120 may be connected to the first terminal 111 and the second terminal 114 as described in FIG. 2A. When the conversion circuit 120 is turned on, alternating current power provided from the wall power source 201 through the first terminal 111 may be converted into direct current power and provided to the second terminal 114. When the conversion circuit 120 is turned off, power may not be provided from the wall power source 201 to the electronic device 101 through the first terminal 111.

According to an embodiment, the communication circuit 130 may support short-range communication (for example, Bluetooth communication (for example, BLE but there is no limitation) or Wi-Fi communication). The communication circuit 130 may be configured to periodically broadcast, for example, a beacon signal (or based on the generation of an event). The communication circuit 130 may identify whether a response signal is received after broadcasting the beacon signal. When the response signal is received, the communication circuit 130 may be configured to provide a signal that causes the conversion circuit 120 to be turned on to the conversion circuit 120. As described above, the communication circuit 130 may not only process the communication signal but also provide the signal for controlling (for example, turning on or turning off) the conversion circuit 120 which is different hardware, and may support a processing function according thereto. At least some of the communication circuit 130 may be an MCU, but there is no limitation in implementation, and those skilled in the art may understand that an MCU for processing a communication signal from the communication circuit 130 and providing a signal for controlling the conversion circuit 120 which is other hardware may be implemented independently from the communication circuit 130.

According to an embodiment, the battery 150 may provide power to the communication circuit and/or the power supply 140. The power supply 140 may provide driving power of the conversion circuit 120 using power provided from the battery 150 while being turned on. The communication circuit 130 may transmit a beacon signal by using power from the battery 150, receive a response signal, process the response signal, and/or provide a signal to the conversion circuit 120 while being turned on. In FIG. 2B, although it is illustrated that the communication circuit 130 performs the operation by directly using the power provided from the battery 150, it is only an example, and those skilled in the art may understand that an additional element for processing power (for example, DC/DC converting) from the battery 150 and providing the power to the communication circuit 130 may be further included in the electronic device 101. In an example, the battery 150 may be a secondary battery that can be chargeable. For example, the battery 150 may be charged using power provided from the conversion circuit 120 while the conversion circuit 120 is turned on. This is merely an example, and those skilled in the art may understand that a charger for processing power from the conversion circuit 120 and charging the battery 150 may be further included in the electronic device 101. The battery 150 may be implemented as a battery that is not a secondary battery.

FIG. 2C is a diagram illustrating an example electronic device according to an embodiment. FIG. 2C is described with reference to FIG. 2D. FIG. 2D is a block diagram illustrating an example configuration of an electronic device according to an embodiment.

According to an embodiment, the electronic device 101 may be implemented in the form to which a plug of the home appliance 1 can be inserted. For example, while the electronic device 101 corresponding to the case where the home appliance 1 as a legacy product has a power interface which can be connected to an adapter has been described in the embodiments of FIGS. 2A and 2B, the electronic device 101 corresponding to the case where the home appliance 1 as a legacy product has a plug 9 which can be connected to the wall power source 210 rather than the power interface which can be connected to the adapter is described in FIGS. 2C and 2D. The electronic device 101 may include a first terminal 111 to be connected to a wall power source 201. The first terminal 111 may have the form that can be inserted into an outlet 201a of the wall power source 201, but there is no limitation. The electronic device 101 may include an electric wire 112 connected to the first terminal 111 and an outlet 115 to which the plug 9 of the home appliance 9 can be inserted. Meanwhile, although it has been described that the electronic device 101 includes the first terminal 111 and the electric wire 112, it is only an example, and those skilled in the art may understand that the electronic device 101 may be implemented in the form that is connected to at least some of the first terminal 111 and the electric wire 112.

Referring to FIG. 2D, the electronic device 101 according to an embodiment may include a charger 125, a switch 127, a communication circuit 130, a battery 150, or an outlet 115. The charger 125 may charge the battery 150 while being turned on. The charger 125 may convert, for example, some of the alternating current power provided from the wall power source 201 to the direct current power suitable for charging the battery 150 and provide the converted power to the battery 150, so that the battery 150 can be charged. Meanwhile, those skilled in the art may understand that another element (for example, a rectification circuit, a converter, or the like, but there is no limitation) for converting alternating current power into direct current power as well as the charger 125 may be included in the electronic device 101, in which case the charger 125 may charge the battery 150 by using the provided direct current power. As described above, the communication circuit 130 may support short-range communication (for example, Bluetooth communication (for example, BLE but there is no limitation) or Wi-Fi communication). The communication circuit 130 may be configured to periodically broadcast, for example, a beacon signal (or based on the generation of an event). The communication circuit 130 may identify whether a response signal is received after broadcasting the beacon signal. When the response signal is received, the communication circuit 130 may be configured to provide a signal that causes the switch 127 and/or the charger 125 to be turned on. As described above, the communication circuit 130 may not only process the communication signal but also provide the signal for controlling (for example, turning on or turning off) the conversion circuit 120 which is different hardware, and may support a processing function according thereto. At least some of the communication circuit 130 may be an MCU, but there is no limitation in implementation, and those skilled in the art may understand that an MCU for processing a communication signal from the communication circuit 130 and providing a signal for controlling the switch 127 and/or the charger 125 may be implemented independently from the communication circuit 130.

The switch 127 may maintain the turned-off state while the main function of the home appliance 1 is turned off. For example, in a first state of the electronic device 101, the switch 127 may be in the turned-off state, the charger 125 may be in the turned-off state, and the communication circuit 130 may be in the turned-on state. During this period, as the switch 127 is turned off, power may not be provided from the wall power source 201 to the electronic device 101 through the first terminal 111. Although the home appliance 1 is connected to the outlet 115, power may not be provided to the home appliance 1, and thus all hardware of the home appliance 1 may be turned off. The communication circuit 130 may transmit a beacon signal using power from the battery 150, receive a response signal, process the response signal, and/or provide a signal to the conversion circuit 120 during the turned-on state. In the embodiment of FIG. 2D, although it is illustrated that the communication circuit 130 performs the operation by directly using power provided from the battery 150, it is only an example, and those skilled in the art may understand that an additional element for processing the power (for example, DC/DC converting) from the battery 150 and providing the power to the communication circuit 130 may be further included in the electronic device 101. In an example, the battery 150 may be a secondary battery that can be chargeable. For example, the battery 150 may be charged using power provided from the conversion circuit 120 while the conversion circuit 120 is turned on. Meanwhile, it is only an example, and those skilled in the art may understand that a charger for processing power from the conversion circuit 120 and charging the battery 150 may be further included in the electronic device 101.

The communication circuit 130 may provide a signal that causes the switch 127 to be turned on and/or a signal that causes the charger 125 to be turned on, based on the response signal being received after the beacon signal is broadcasted. The switch 127 may be turned on and power from the wall power source 201 may be provided to the electronic device 101. At least some of the power from the wall power source 210 may be provided to the home appliance 101 through the outlet 115. The home appliance 101 may turn on the main function or may be in an idle state, which will be described below. At least some of the power from the wall power source 210 may be provided to the charger 125, and the charger 125 may charge the battery 150.

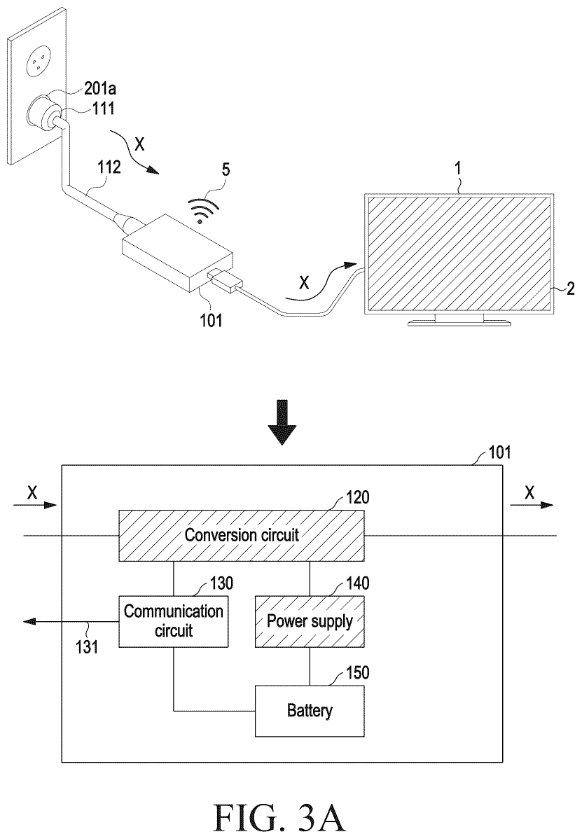

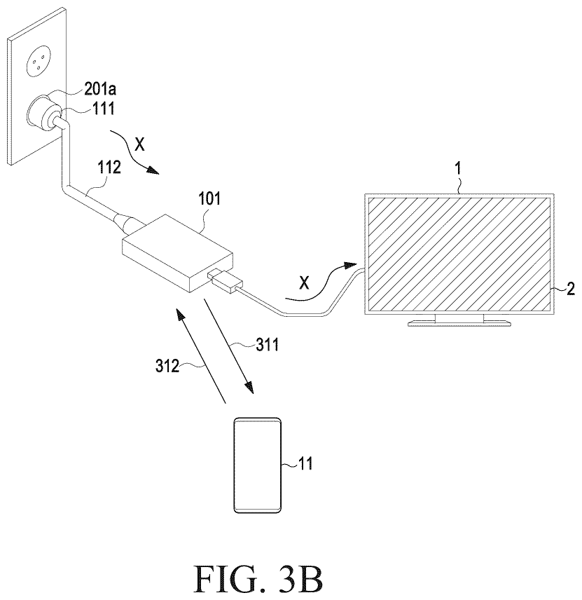

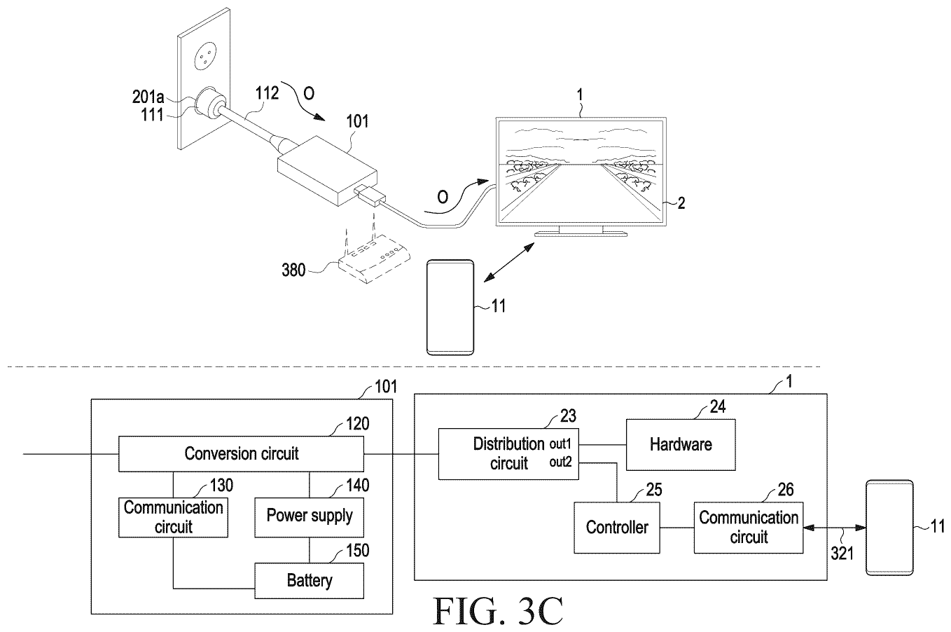

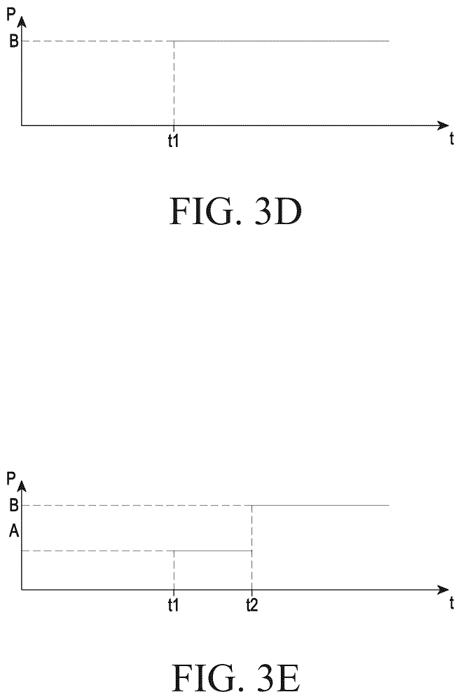

FIG. 3A is a diagram illustrating an example operation of an electronic device while a main function of a home appliance is turned off according to an embodiment.

According to an embodiment, the electronic device 101 may be implemented in the form such as the adapter as illustrated in FIGS. 2A and 2B. The second terminal 114 included in (or connected to) the electronic device 101 may be connected to the home appliance 1. The home appliance 1 is a legacy product and expressed as TV in FIG. 3A, but there is no limitation in the type of home appliance. In the first state of the electronic device 101, the conversion circuit 120 and the power supply 140 may be turned off and the communication circuit 130 may be turned on. As the conversion circuit 120 is turned off, power may not be provided from the wall power source 201 to the electronic device 101, and power also may not be provided to the home appliance 1. The communication circuit 130 may be turned on in the first state and may broadcast a beacon signal 131 periodically (or based on the generation of an event). The communication circuit 130 may operate using power from the battery 150. When there is no external electronic device 11 around, the electronic device 101 may maintain the first state. The communication circuit 130 may repeat transmission of the beacon signal 131 using power from the battery 150. Accordingly, the power from the wall power source 201 may be blocked, and thus no power may be consumed while the operation of the home appliance 1 is not required (or the home appliance may operate with super-low power to consume only power of the battery 150).

FIGS. 3B and 3C are diagrams illustrating example operations of an electronic device while and/or after a home appliance is turned on according to an embodiment.

Referring to FIG. 3B, the external electronic device 11 may be disposed near the electronic device 101 (for example, within the coverage of the communication circuit 130 of the electronic device 101). For example, the user may move to a space in which the home appliance 1 and the electronic device 101 are disposed while carrying the external electronic device 11. The external electronic device 11 may receive a beacon signal 311 from the communication circuit 130. The external electronic device 11 may transmit a response signal 312 corresponding to the beacon signal 311. For example, when the beacon signal 311 is received, the external electronic device 11 (or an application executed in the external electronic device 11) may be configured to trigger the same and transmit the response signal 312. When the beacon signal 311 is received, the external electronic device 11 may be configured to provide a UI that inquires about whether to turn on the home appliance 1 and transmit the response signal 312, based on a user command through the UI being identified.

Referring to FIG. 3C, the electronic device 101 may turn on the conversion circuit 120 and/or the power supply 140, based on the response signal 312 being received. For example, the communication circuit 130 may provide a signal that causes the conversion circuit 120 to be turned on and/or a signal that causes the power supply 140 to be turned on, based on the response signal 312 being received. As the conversion circuit 120 is turned on, alternating current power may be provided from the wall power source 201 to the electronic device 101. The conversion circuit 120 may convert alternating current power to direct current power and provide the direct current power to the home appliance 1.

The home appliance 1 may include a distribution circuit 23, hardware 24 for the main function, a controller 25, and/or a communication circuit 26. The home appliance 1 may receive direct current power provided from the electronic device 101. The distribution circuit 23 may provide power to the hardware 24 for the main function, the controller 25, and/or the communication circuit 26. The communication circuit 26 may establish a communication connection 321 with the external electronic device 11. A procedure for establishing the communication connection 321 may be defined according to a short-range communication scheme. Thereafter, according to the control by the user, the external electronic device 11 may transmit a communication signal for remotely controlling the home appliance 1 through the communication connection 321. The external electronic device 11 may directly establish the communication connection 321 with the home appliance 1 or may perform communication through a relay device 380. The electronic device 101 may deactivate, for example, the communication 130 but there is no limitation, and the communication circuit 130 may maintain the turned-on state.

FIG. 3D is a graph illustrating power consumed by a home appliance 1 according to an embodiment. For example, it is assumed that the electronic device 101 turns on the conversion circuit 120 and power is provided to the home appliance 1 at a time point t1. Since there is no power provided to the home appliance 1 before the time point t1, power consumed by the home appliance 1 may be actually 0. After the time point t1, all hardware of the home appliance 1 may be turned on, and accordingly power consumption of “B” may be consumed. In comparison with the comparative example of FIG. 1, according to an embodiment, power consumption may decrease from “A” to 0 while the main function of the home appliance 1 is turned off.

According to an embodiment, when power is provided from the electronic device 101, the home appliance 1 may enter the idle state without directly turning on the hardware 24 for the main function. In the idle state, the hardware 24 for the main function may be turned off and, for example, power consumption of the home appliance 1 may be “A” similar to FIG. 1B of the home appliance 1. In the idle state, the communication circuit 26 of the home appliance 1 may be turned on, and accordingly the home appliance 1 may establish the communication connection 321 with the external electronic device 11. In the idle state, since the communication circuit 26 of the home appliance 1 can be turned on, the home appliance 1 may be in the state in which the remote control is possible. After the time point t2, the user may control the external electronic device 11 to remotely turn on the home appliance 1. The external electronic device 11 may transmit a signal that cause the home appliance 1 to be totally turned on through the established communication connection 321. The home appliance 1 may turn on all elements including the hardware 24 for the main function, based on the corresponding signal being received.

FIG. 3E is a graph illustrating power consumed by a home appliance 1 supporting an idle state. For example, it is assumed that the electronic device 101 turns on the conversion circuit 120 and power is provided to the home appliance 1 at the time point t1. Since there is no power provided to the home appliance 1 before the time point t1, power consumed by the home appliance 1 may be actually 0. After the time point t1, the home appliance 1 may be in the idle state, and accordingly power consumption of “A” may be consumed. Meanwhile, as described above, at the time point t2, a signal for turning on from the external electronic device 11 may be received by the home appliance 1. According to the reception of the signal for turning on, all hardware may be turned on, and accordingly power consumption of “B” may be consumed. When the signal for turning on is not received for a specified period after entering the idle state, the home appliance 1 may be completely turned off again. In this case, the electronic device 101 may enter the first state again. For example, when a user command for turning on is not received for a specified threshold period, the external electronic device 11 may transmit a communication signal that instructs returning to the first state again to the electronic device 101. Alternatively, when the time during which the magnitude of power drawn by the external electronic device 11 is equal to or smaller than a threshold value (for example, smaller than B but there is no limitation) arrives a specified threshold period, the electronic device 101 may return to the first state. Alternatively, based on the external electronic device 11 escaping to the outside of the communication range, the electronic device 101 may return to the first state and there is no limitation in an event for returning to the first state.

For example, when the user approaches the electronic device 101 and the home appliance 1 while carrying the external electronic device 11, the external electronic device 11 may respond to the beacon signal from the electronic device 101 and transmit a response signal without nay intervention of the user. In this case, it may be implemented that the home appliance 1 may directly turn on the main function as described in FIGS. 3C and 3D or turn on the main function when a turn-on signal is additionally received after first entering the idle state as described in FIG. 3E.

When the user approaches the electronic device 101 and the home appliance 1 while carrying the external electronic device 11, the external electronic device 11 may provide a UI that inquires about whether to turn on the home appliance 1, based on the beacon signal from the electronic device 101. When the turn-on command of the home appliance 1 is received through the UI, the external electronic device 11 may transmit a response signal that causes turning on.

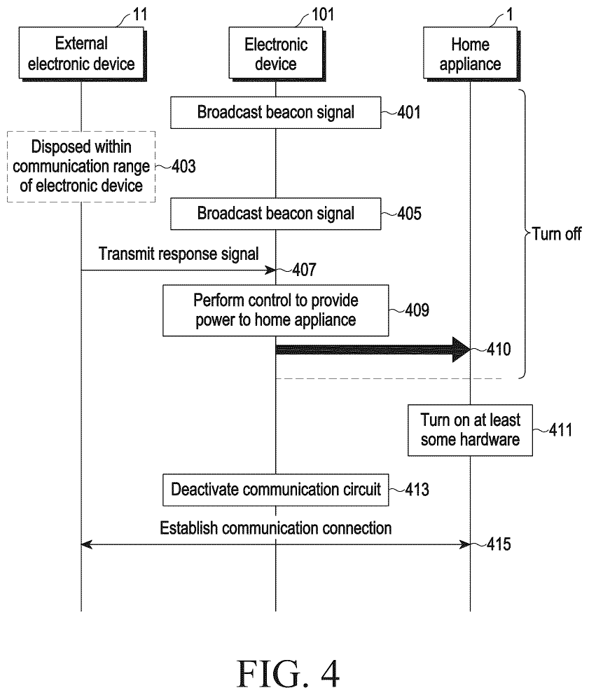

FIG. 4 is a signal flow diagram illustrating an example method of operating an electronic device, a home appliance, and an external electronic device according to an embodiment.

According to an embodiment, the electronic device 101 may broadcast a beacon signal in operation 401. The electronic device 101 may broadcast the beacon signal in a first state. In the first state, for example, the conversion circuit 120 and/or the power supply 140 of the electronic device 101 may be turned off, and the communication circuit 130 may be turned on. The communication circuit 130 may broadcast the beacon signal by using power from the battery 150 periodically (or based on the detection of an event). Meanwhile, it is assumed that the external electronic device 11 is located within a communication range of the electronic device 101 at the time point at which the beacon signal is broadcasted in operation 401. The electronic device 101 may maintain the first state, based on a response signal corresponding to the beacon signal not being received.

It is assumed that the external electronic device 11 is disposed within the communication range of the electronic device 101 in operation 403 after the electronic device 101 broadcasts the beacon signal in operation 401. Operation 403 may be indicated by dotted lines because it is not the operation performed by the external electronic device 11. The electronic device 101 may broadcast the beacon signal in operation 405 after the time point of operation 403. The electronic device 101 may broadcast the beacon signal in the first state.

The external electronic device 11 may receive the beacon signal broadcasted from the electronic device 101. The external electronic device 11 may transmit a response signal corresponding to the beacon signal to the electronic device 101 in operation 407. In an example, the external electronic device 11 may be configured to transmit the response signal in response to reception of the beacon signal without any intervention of the user. In an example, the external electronic device 11 may provide a UI that inquires about whether to turn on the home appliance 1, based on the beacon signal being received. When a turn-on command of the home appliance 1 is identified through the UI, the electronic device 101 may be configured to transmit the response signal.

According to an embodiment, the electronic device 101 may perform control to provide power 410 to the home appliance in operation 409, based on the response signal corresponding to the beacon signal being received. For example, the electronic device 101 may turn on the conversion circuit 120. The conversion circuit 120 may convert alternating current power from the wall power source 201 to direct current power, and accordingly, the power 410 may be provided to the home appliance 1. Through reception of the power 410 of the home appliance 1, at least some hardware may be turned on in operation 411. In an example, the home appliance 1 may turn on all hardware including the hardware 24 for the main function as described with reference to FIGS. 3C and 3D. In an example, the home appliance 1 may turn on hardware (for example, the communication circuit 26) for the idle state except for the hardware 24 for the main function as described with reference to FIG. 3E.

According to an embodiment, the electronic device 101 may deactivate the communication circuit 130 in operation 413. This is only an example, and the electronic device 101 may maintain the active state of the communication circuit 130. The home appliance 1 may establish a communication connection with the external electronic device 11 in operation 415. Accordingly, the external electronic device 11 may transmit a communication signal for remotely controlling the home appliance 1 to the home appliance 1. Alternatively, when the communication signal is received from the home appliance 1, the external electronic device 11 may provide the same.

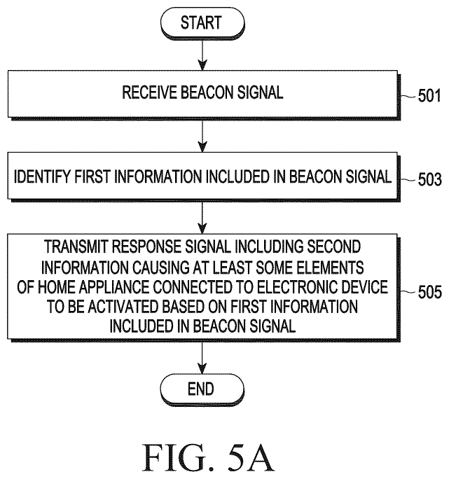

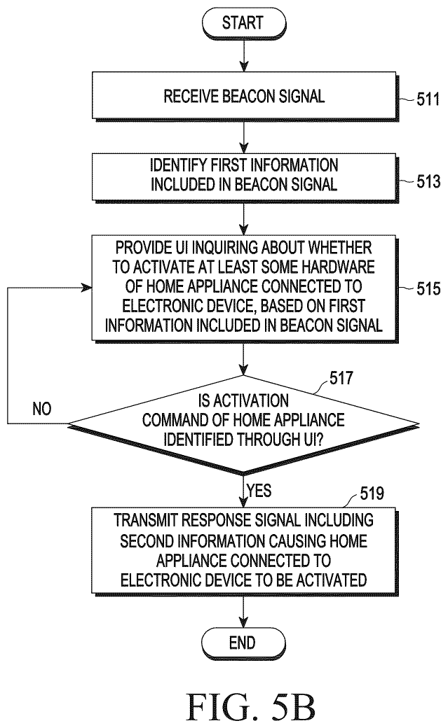

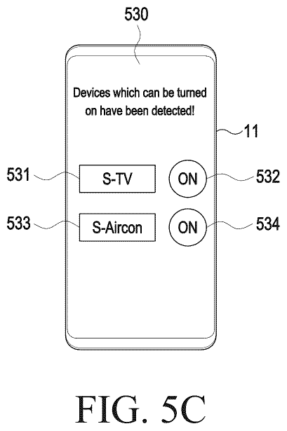

FIG. 5A is a flowchart illustrating an example method of operating an external electronic device according to an embodiment.

The external electronic device 11 according to an embodiment may receive a beacon signal in operation 501. As described above, the electronic device 101 according to an embodiment may transmit the beacon signal in a first state. The external electronic device 11 may receive the beacon signal transmitted from the electronic device 101.

The external electronic device 11 may identify first information included in the beacon signal in operation 503. The external electronic device 101 may transmit, to the electronic device 101, a response signal including second information (or second information that causes the electronic device 101 to provide power to the home appliance) that causes activation of at least some elements of the home appliance 1 connected to the electronic device 101, based on first information included in the beacon signal in operation 505.

For example, the first information may be, for example, information that causes transmission of the response signal. The external electronic device 11 may be configured to transmit the response signal, based on the information that causes transmission of the response signal being identified. For example, the first information may include, for example, information for additionally (or alternatively) identifying the home appliance 1. The external electronic device 11 may transmit the response signal, based on the information for identifying the home appliance 1. For example, when the home appliance 1 is an electronic device registered in association with a user account for IoT control, the external electronic device 11 may transmit the response signal.

The electronic device 101 may determine whether to provide power to the home appliance 1, based on information included in the response signal. For example, the electronic device 101 may determine whether to provide power to the home appliance 1, based on whether the external electronic device 11 included in the response signal is the device registered in association with the user account for IoT control. When the external electronic device 11 included in the response signal is not registered in association with the user account for IoT control, the electronic device 101 may maintain the first state (that is, maintain non-provision of power) even though the response signal is received.

FIG. 5B is a flowchart illustrating an example method of operating an external electronic device according to an embodiment. The embodiment of FIG. 5B is described with reference to FIG. 5C. FIG. 5C is a diagram illustrating an example UI provided by an external electronic device according to an embodiment.

The external electronic device 11 according to an embodiment may receive a beacon signal in operation 511. As described above, the electronic device 101 according to an embodiment may transmit the beacon signal in a first state. The external electronic device 11 may receive the beacon signal transmitted from the electronic device 101. The external electronic device 11 may identify first information included in the beacon signal in operation 513. The external electronic device 11 may provide a UI that inquires about whether to activate at least some hardware of the home appliance 1 connected to the electronic device 101, based on first information included in the beacon signal in operation 515. The external electronic device 11 may identify whether an activation command of a specific home appliance is identified through the UI in operation 517. When the activation command is identified (517-Yes), the external electronic device 11 may transmit a response signal including second information that causes activation of the home appliance 1 connected to the electronic device 101 to the electronic device 101 in operation 519. For example, as illustrated in FIG. 5C, those skilled in the art may understand that the external electronic device 11 may display a UI 530 but another type of UI other than the visual screen is also possible. The UI 530 may include identification information 531 and 533 of home appliances (for example, associated with the electronic device receiving the beacon signal) detected by the external electronic device 11 and objects 532 and 534 for turning on the corresponding home appliances. When a user designation for a specific object 532 is identified, the external electronic device 11 may transmit a response signal to the electronic device 101 connected to the corresponding home appliance. When there are a plurality of home appliances and electronic devices connected to the respective home appliances in a specific space, the external electronic device 11 may transmit a response signal to an electronic device designated by a user selection, so as to turn on the specific home appliance.

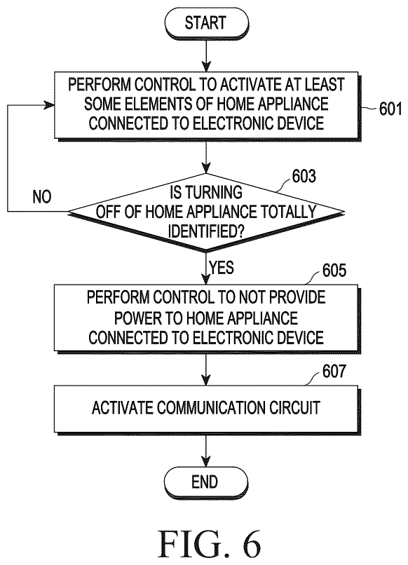

FIG. 6 is a flowchart illustrating an example method of operating an external electronic device according to an embodiment.

The electronic device 101 according to an embodiment may perform control to activate at least some elements of the home appliance 1 connected to the electronic device 101 in operation 601. For example, as described with reference to FIGS. 3C, 3D, and/or 3E, the electronic device 101 may turn on the conversion circuit 120, and accordingly power (or converted power) from the wall power source 201 may be provided to the home appliance 1. The electronic device 101 may identify whether the home appliance 1 is totally (e.g., completely) turned off in operation 603. When it is identified that the home appliance 1 is totally turned off (603-Yes), the electronic device 101 may perform control to not provide power to the home appliance 1 connected to the electronic device 101 in operation 605. When the communication circuit 140 is deactivated, the electronic device 101 may activate the communication circuit 140 in operation 607.

For example, the electronic device 101 may identify whether the home appliance 1 is turned off again, based on the magnitude of power drawn by the home appliance 1. When it is identified that the power provided to the home appliance 1 is actually 0, the electronic device 101 may identify that the home appliance 1 is turned off again. When the electronic device 101 maintains activation of the communication circuit 140, it may be identified whether the home appliance 1 is turned off again based on a communication signal from the external electronic device 101, but it is only an example and there is no limitation in a scheme for identifying turning off of the home appliance 1.

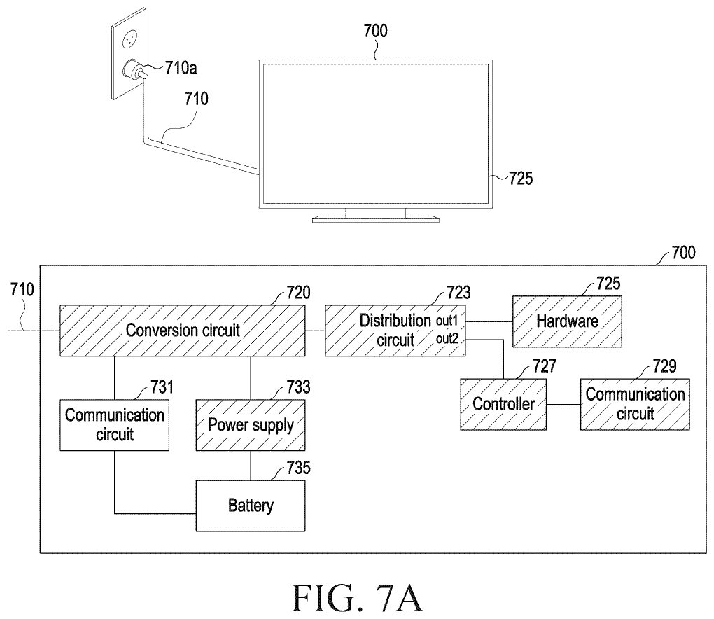

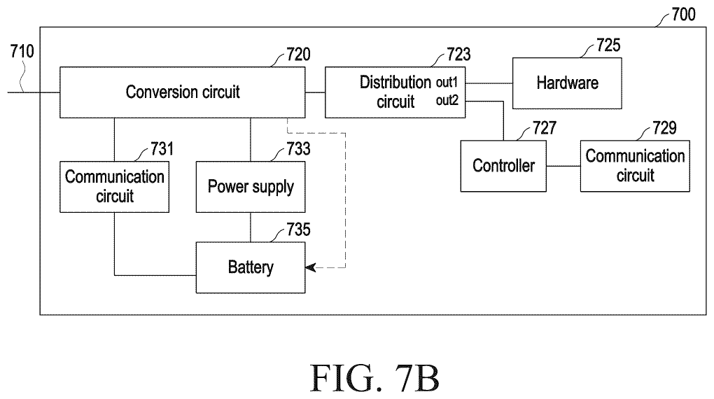

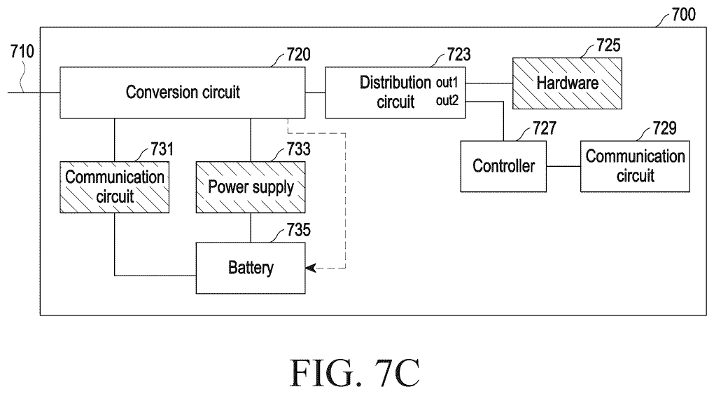

FIGS. 7A, 7B and 7C are block diagrams illustrating example configurations of an electronic device according to an embodiment. For example, while the embodiment according to FIGS. 2A and 2B describe the electronic device which can be connected to the legacy home appliance, the electronic device according to the embodiment of FIGS. 7A to 7C may be implemented as the home appliance. An electronic device 700 according to an embodiment may include an electric wire 710, a terminal 710a connected to the electric wire 710, a conversion circuit 720, a distribution circuit 723, hardware 725 for a main function, a controller 727, a communication circuit 729, a communication circuit 731, a power supply 733, and/or a battery 735. Meanwhile, FIGS. 7A and 7B illustrate that the communication circuit 729 and the communication circuit 731 are independent from each other but it is only an example, and those skilled in the art may understand that the communication circuits may be implemented as a signal communication circuit. The terminal 710a may be connected to, for example, a wall power source. The hardware 725 for the main function is illustrated as, for example, a display module, but it is only an example.

FIG. 7A illustrates the case where the main function of the electronic device 700 is turned off, and when the main function is turned off, the communication circuit 731 may be turned on and the remaining elements may be turned off. The state in which the main function is turned off and the communication circuit 731 is turned on may be called a first state for convenience of description. The communication circuit 731 may support short-range communication (for example, Bluetooth communication (for example, BLE but there is no limitation) or Wi-Fi communication). The communication circuit 731 may be configured to periodically broadcast, for example, a beacon signal (or based on the generation of an event). The communication circuit 731 may identify whether a response signal is received after broadcasting the beacon signal. When a response signal is received, the communication circuit 731 may be configured to provide a signal that causes the conversion circuit 720, the distribution circuit 723, the hardware 725, the controller 727, the communication circuit 729, and/or the power supply 733 to be turned on. As described above, the communication circuit 731 may not only process the communication signal but also provide the signal for controlling (for example, turning on or turning off) the conversion circuit 731 which is different hardware, and may support a processing function according thereto. At least some of the communication circuit 731 may be an MCU but there is no limitation in implementation. Meanwhile, the remaining elements except for the communication circuit 731 may be turned off and thus the electronic device 700 may not receive power from the wall power source 201, so that no power may be consumed (or the operation may be performed with super-low power to consume only power of the battery 150) while the operation of the electronic device 700 is not required.

FIG. 7B illustrates a case where the main function of the electronic device 700 is turned on. In order to turn on the main function, all of the elements included in the electronic device 700 may be turned on, which may be called a third state for convenience of description. For example, in the first state of FIG. 7A, the communication circuit 731 may transmit a beacon signal periodically (or based on the detection of an event). For example, when the external electronic device 11 is not disposed around the electronic device 700 (or within a communication range of the electronic device 700), the electronic device 700 cannot receive a response signal and accordingly may maintain the first state. When the external electronic device 11 is disposed around the electronic device 700 (or within the communication range of the electronic device 700), the external electronic device 11 may transmit a response signal corresponding to the beacon signal to the electronic device 700. The electronic device 700 may transition from the first state to the third state, based on the response signal corresponding to the beacon signal, being received. In the third state, the electronic device 700 may turn on all of the elements.

According to an embodiment, when turned on, the conversion circuit 720 may convert alternating current power provided from the wall power source 201 into direct current power and provide the direct current power to the distribution circuit 723. No power may be provided from the wall power source 201 to the electronic device 700 while the conversion circuit is turned off. The distribution circuit 723 receiving power from the conversion circuit 720 may provide power through terminals (out 1 and out 2). For example, power may be provided to the hardware 725 for the main function of the electronic device 700 through the terminal (out 1). The hardware 725 for the main function may include at least one hardware according to the purpose of the electronic device 700. When the electronic device 700 is TV, the hardware 725 may be a display module for providing visual content that is the main function of TV, a speaker, or the like, and there is no limitation in the type of the electronic device 700 and/or the hardware 725 corresponding thereto. In the third state, the hardware 725 may receive power to operate. In the third state, the controller 727 and/or the communication circuit 729 may receive power from the distribution circuit 723 to operate. The controller 727 may be implemented as, for example, a processor (e.g., including processing circuitry), an MCU, an FPGA, an ASIC, or the like, but those skilled in the art may understand that there is no limitation if the controller is a means for processing instructions (or programs or applications). The processor of the controller 722 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The communication circuit 729 may support, for example, short-range communication (for example, Bluetooth communication or Wi-Fi communication) and there is no limitation in the type of short-range communication. The communication circuit 729 may transmit a communication signal from the external electronic device 11 and/or transmit a communication signal through, for example, short-range communication (or through a relay device). The communication circuit 729 may support, for example, IR-based communication and receive an IR-based signal from, for example, a remote controller. As described above, the communication circuit 729 may be implemented independently from the communication circuit 731 activated in the first state or may be implemented as a signal element with the communication circuit 731 (that is, one communication circuit is included in the electronic device 700). When one communication circuit is implemented, the communication circuit may receive power from the battery 735 during the first state and may receive power from the distribution circuit 723 during the third state.

According to an embodiment, the battery 735 may provide power to the communication circuit and/or the power supply 733. The power supply 733 may provide driving power of the conversion circuit 720 by using power provided from the battery 735 during the turned-on state. The conversion circuit 720 may receive power from the distribution circuit 723 during the third state in which case the power supply 733 may not be included in the electronic device 700. In the third state, the battery 735 may be charged based on power from the conversion circuit 720 or the distribution circuit 723. A charger for processing power from the conversion circuit 720 or the distribution circuit 723 and charging the battery 735 may be further included in the electronic device 101. The battery 735 may be implemented as a battery that is not a secondary battery.

FIG. 7C illustrates the idle state of the electronic device 700. In the idle state, the conversion circuit 720, the distribution circuit 723, the controller 727, and the communication circuit 729 may be turned on. The idle state may be referred to as a second state for convenience of description. According to implementation, the communication circuit 731 may be turned off, but the turning off may be an example. In the idle state, the hardware 725 may be turned off. For example, in the first state of FIG. 7A, the communication circuit 731 may transmit a beacon signal periodically (or based on the detection of an event). For example, when the external electronic device 11 is not disposed around the electronic device 700 (or within a communication range of the electronic device 700), the electronic device 700 cannot receive a response signal and accordingly may maintain the first state. When the external electronic device 11 is disposed around the electronic device 700 (or within the communication range of the electronic device 700), the external electronic device 11 may transmit a response signal corresponding to the beacon signal to the electronic device 700. The electronic device 700 may transition from the first state to the idle state, based on the response signal corresponding to the beacon signal, being received. The electronic device 700 may transition to the third state of FIG. 7B, based on the response signal being received in the first state in an example or may transition to the idle state of FIG. 7C, based on the response signal being received in the first state in another example, In the idle state, the communication circuit 729 may establish a communication connection with the external electronic device 11. The communication circuit 729 may receive a communication signal that causes the electronic device 700 to be turned on from, for example, the external electronic device 11. The controller 727 may process the communication signal and turn on all of the elements of the electronic device 700 (for example, enter the third state).

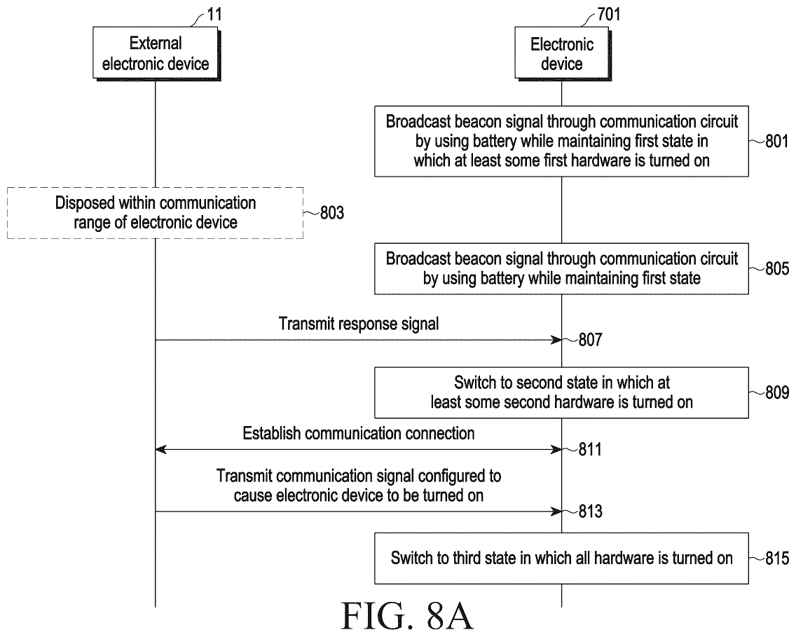

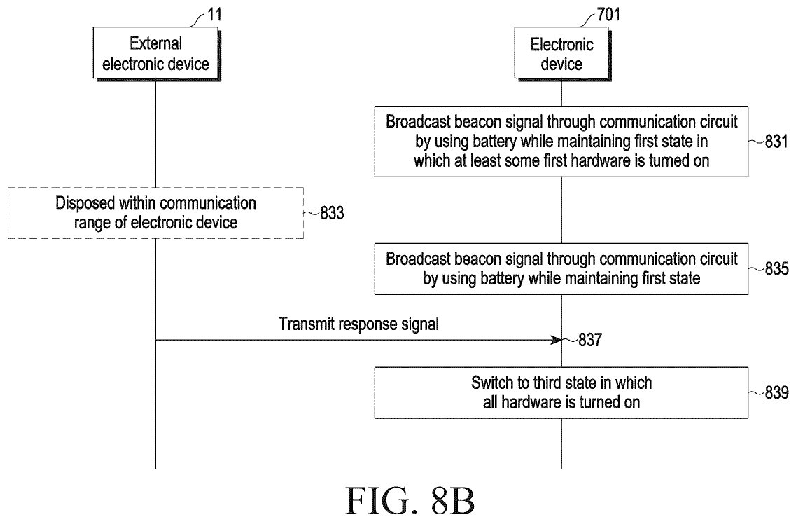

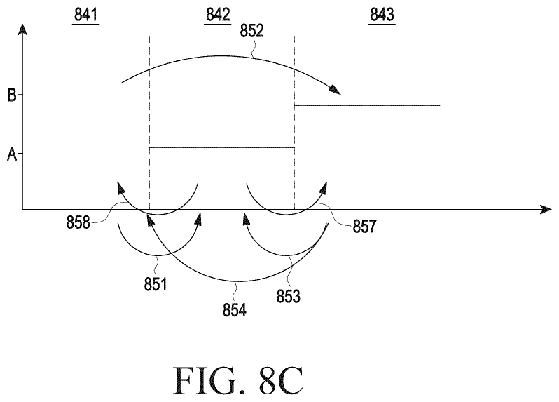

FIG. 8A is a signal flow diagram illustrating an example method of operating an electronic device and an external electronic device according to an embodiment.

According to an embodiment, the electronic device 700 may broadcast a beacon signal through the communication circuit 731 using the battery 735 while maintaining a first state in which at least some first hardware is turned on in operation 801. At least some first hardware may be, for example, the communication circuit 731 as described in FIG. 7A, but there is no limitation. It is assumed that the external electronic device 11 is located within a communication range of the electronic device 700 at the time point at which the beacon signal is broadcasted in operation 801. The electronic device 700 may maintain the first state, based on a response signal corresponding to the beacon signal not being received.

It is assumed that the external electronic device 11 is disposed within the communication range of the electronic device 101 in operation 803 after the electronic device 700 broadcasts the beacon signal in operation 801. Operation 803 may be indicated by dotted lines because it is not the operation performed by the external electronic device 11. The electronic device 700 may broadcast the beacon signal in operation 805 after the time point of operation 803. The electronic device 700 may broadcast the beacon signal in the first state.

The external electronic device 11 may receive the beacon signal broadcasted from the electronic device 700. The external electronic device 11 may transmit a response signal corresponding to the beacon signal to the electronic device 101 in operation 807. In an example, the external electronic device 11 may be configured to transmit the response signal in response to reception of the beacon signal without any intervention of the user, but there is no limitation.

According to an embodiment, the electronic device 700 may switch to a second state (or an idle state) in which at least some second hardware is turned on, based on the response signal corresponding to the beacon signal being received in operation 809. At least some second hardware may include, for example, the conversion circuit 720, the distribution circuit 723, the controller 727, the communication circuit 729, and/or the power supply 733 as described with reference to FIG. 7C but there is no limitation. In the second state, the electronic device 700 may establish a communication connection with the surrounding external electronic device 11 through the communication circuit 729 in operation 811.

According to an embodiment, the external electronic device 11 may transmit a communication signal configured to cause the electronic device 700 to be turned on in operation 813. The electronic device 700 may switch to a third state in which all hardware is turned on in operation 815. For example, the external electronic device may provide a UI that inquires about whether to turn on the electronic device 700. When a turn-on command of the electronic device 700 is identified through the UI, the external electronic device 11 may be configured to transmit a signal that causes the electronic device 700 to be turned on.

FIG. 8B is a signal flow diagram illustrating an example method of operating an electronic device and an external electronic device according to an embodiment.

According to an embodiment, the electronic device 700 may broadcast a beacon signal through the communication circuit 731 using the battery 735 while maintaining a first state in which at least some first hardware is turned on in operation 831. At least some first hardware may be, for example, the communication circuit 731 as described in FIG. 7A, but there is no limitation. Meanwhile, it is assumed that the external electronic device 11 is not located within a communication range of the electronic device 700 at the time point at which the beacon signal is broadcasted in operation 831. The electronic device 700 may maintain the first state, based on a response signal corresponding to the beacon signal not being received.

It is assumed that the external electronic device 11 is disposed within the communication range of the electronic device 101 in operation 833 after the electronic device 700 broadcasts the beacon signal in operation 831. Operation 833 may be indicated by dotted lines because it is not the operation performed by the external electronic device 11. The electronic device 700 may broadcast the beacon signal in operation 835 after the time point of operation 833. The electronic device 700 may broadcast the beacon signal in the first state.

The external electronic device 11 may receive the beacon signal broadcasted from the electronic device 700. The external electronic device 11 may transmit a response signal corresponding to the beacon signal to the electronic device 101 in operation 837. In an example, the external electronic device 11 may be configured to transmit the response signal in response to reception of the beacon signal without any intervention of the user. The external electronic device 11 may provide a UI that inquiries about whether to turn on the electronic device 700, based on the beacon signal being received. When a turn-on command of the electronic device 700 is identified through the UI, the external electronic device 11 may be configured to transmit a response signal. The electronic device 700 may switch to the third state in which all hardware is turned on in operation 839.

FIG. 8C is a graph illustrating switching between states of an electronic device according to an embodiment.

According to an embodiment, the electronic device 700 may switch from a first state 841 to a second state 842 (for example, the idle state) as indicated by reference numeral 851. The electronic device 700 may transmit a beacon signal in the first state 841 and switch to the second state 842, based on a response signal corresponding to the beacon signal being received as indicated by reference numeral 851. In the first state 841, for example, no power is provided from the wall power source 201, and power consumption may be actually 0 (or there is only power consumption by the battery 735). In the second state 842, for example, the conversion circuit 720, the distribution circuit 723, the controller 727, the communication circuit 729, and/or the power supply 733 may be turned on and, for example, power consumption of “A” may be consumed. In the third state, all hardware of the electronic device 700 may be turned on and, for example, power consumption of “B” may be consumed. In another example, the electronic device 700 may switch from the first state 841 to the third state 842 as indicated by reference numeral 852. The electronic device 700 may transmit a beacon signal in the first state 841 and switch to the third state 843, based on a response signal corresponding to the beacon signal being received as indicated by reference numeral 852. The electronic device 700 may transmit the beacon signal in the first state 841 and switch to the third state 843, based on a communication signal causing the electronic device 700 to be turned on being received, as indicated by reference numeral 852.

The electronic device 700 may switch from the second state 842 to the third state 843 as indicated by reference numeral 858. For example, in the second state 842, the electronic device 700 may receive the communication signal that causes the electronic device 700 to be turned on from the external electronic device 11 and switch to the third state 843, based thereon as indicated by reference numeral 853. The electronic device 700 may switch from the second state 842 to the first state 841 as indicated by reference numeral 857. For example, the electronic device 700 may switch from the second state 842 to the first state 841, based on the communication signal that causes turning on, not being received for a specified period in the second state 842 and/or the external electronic device 11 escaping to the outside of the communication range as indicated by reference numeral 857. The electronic device 700 may switch from the third state 843 to the second state 842 as indicated by reference numeral 853 or may switch from the third state 843 to the first state 841 as indicated by reference numeral 854. The electronic device 700 may receive, for example, a communication signal that causes the electronic device 700 to be turned off, and may switch from the third state 843 to the second state 842 as indicated by reference numeral 853 or switch from the third state 843 to the first state 841 as indicated by reference numeral 854, based thereon.

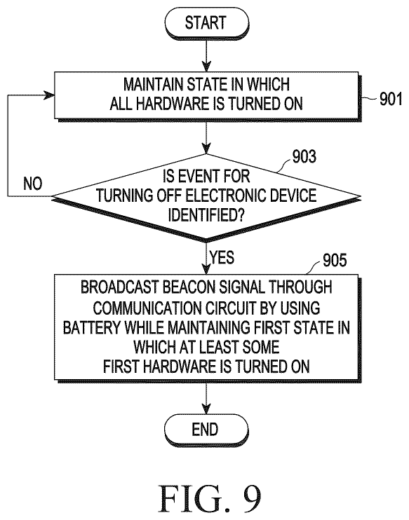

FIG. 9 is a flowchart illustrating an example method of operating an external electronic device according to an embodiment.

An electronic device 700 according to an embodiment may maintain a state (for example, a third state) in which all hardware of the electronic device 700 is turned on in operation 901. The electronic device 700 may identify whether a turn-off event of the electronic device 700 is identified in operation 903. When the turn-off event of the electronic device 700 is identified (903-Yes), the electronic device 700 may broadcast a beacon signal through the communication circuit 731 using a battery 735 while maintaining the first state in which at least some first hardware is turned on in operation 905. As the electronic device 700 maintains the first state, the electronic device 700 may not receive power from the wall power source 201.

According to an example embodiment, the electronic device may include: a battery, a first terminal configured to be connected to a wall power source, a second terminal configured to be connected to a home appliance, a conversion circuit configured to convert alternating current power provided from the wall power source through the first terminal, into direct current power and provide the direct current power through the second terminal, a power supply configured to provide power for the operation of the conversion circuit using power provided from the battery, and a communication circuit configured to operate using the power provided from the battery. The communication circuit may be configured to periodically broadcast a beacon signal using the power provided from the battery in a state in which the conversion circuit is turned off. In the state in which the conversion circuit is turned off, the electronic device may not receive the alternating current power from the wall power source through the first terminal, and the direct current power may not be provided to the home appliance through the second terminal. The communication circuit may be configured to provide a signal that causes the conversion circuit to be turned on to the conversion circuit, based on a response signal to the beacon signal being received from an external electronic device.

According to an example embodiment, the conversion circuit may be configured to be turned on using power provided from the power supply, based on a signal, causing the communication circuit to be turned on, being received and configured to convert the alternating current power from the wall power source into the direct current power and provide the direct current power to the home appliance through the second terminal.

According to an example embodiment, the battery may be configured to be charged using at least some of the direct current power provided from the conversion circuit.

According to an example embodiment, the communication circuit may be configured to enter an inactive state after providing the signal causing turning on to the conversion circuit.

According to an example embodiment, the communication circuit may be configured to provide a signal causing the conversion circuit to be turned off to the conversion circuit, based on the home appliance being turned off after providing the signal causing the turning on to the conversion circuit.

According to an example embodiment, the communication circuit may be configured to identify whether the home appliance is turned off, based on a communication signal, configured to cause the home appliance to be turned off, being received from the external electronic device and/or a change in the magnitude of power output through the second terminal.

According to an example embodiment, the communication circuit may be configured to provide the signal causing the conversion circuit to be turned on to the conversion circuit, based on information included in the response signal satisfying a specified condition.

According to an example embodiment, an electronic device may include: a battery, a terminal configured to be connected to a wall power source, a conversion circuit configured to convert alternating current power, provided from the wall power source through the terminal, into direct current power, a distribution circuit configured to distribute the direct current power, a controller, comprising processing circuitry, connected to the distribution circuit, and a communication circuit configured to operate using power provided from the battery. The communication circuit may be configured to periodically broadcast a beacon signal using the power provided from the battery in a state in which a main function of the electronic device is turned off. In the state in which a main function of the electronic device is turned off, the electronic device may be configured to not receive the alternating current power from the wall power source through the terminal, and power is not provided to the conversion circuit, the distribution circuit, and the controller. The communication circuit may be configured to provide a signal causing the conversion circuit to be turned on to the conversion circuit, based on a response signal corresponding to the beacon signal being received from an external electronic device.

According to an example embodiment, the electronic device may further include: a power supply configured to provide power to the conversion circuit using power from the battery. The conversion circuit may be configured to be turned on using power from the power supply, based on the signal, configured to cause turning on, being received from the communication circuit and configured to convert the alternating current power from the wall power source into the direct current power and provide the direct current power to the distribution circuit.

According to an example embodiment, the electronic device 700 may further include at least one hardware for the main function. The at least one hardware may be turned on by using power provided from the distribution circuit 723.

According to an example embodiment, the controller may be configured to be turned on based on power provided from the distribution circuit. The controller may be configured to establish a communication connection with the external electronic device through the communication circuit or another communication circuit included in the electronic device.

According to an example embodiment, the electronic device may further include at least one hardware for the main function. The controller may be configured to control the at least one hardware to be turned on based on a communication signal, configured to cause the at least one hardware to be turned on, being received through the communication connection.

According to an example embodiment, the battery may be configured to be charged using at least some of the direct current power provided from the conversion circuit.

According to an example embodiment, the communication circuit may be configured to enter an inactive state after providing the signal causing turning on to the conversion circuit.

According to an example embodiment, the controller may be configured to: turn off the conversion circuit and/or the controller and activate the communication circuit, based on an event for turning off the electronic device, being identified.

According to an example embodiment, the communication circuit may be configured to provide the signal causing the conversion circuit to be turned on to the conversion circuit, based on information included in the response signal satisfying a specified condition.

According to an example embodiment, a method of operating an electronic device including a battery, a terminal configured to be connected to a wall power source, a conversion circuit configured to convert alternating current power, provided from the wall power source through the terminal, into direct current power, a distribution circuit configured to distribute the direct current power, a controller, comprising processing circuitry, connected to the distribution circuit, and a communication circuit configured to operate using power provided from the battery may include: periodically broadcasting a beacon signal using the power provided from the battery in a state in which a main function of the electronic device is turned off. In the state in which a main function of the electronic device is turned off, the electronic device may not receive the alternating current power from the wall power source through the terminal, and power is not provided to the conversion circuit, the distribution circuit, and the controller. The method of operating the electronic device may include: providing a signal causing the conversion circuit to be turned on to the conversion circuit, based on a response signal corresponding to the beacon signal being received from an external electronic device.

According to an example embodiment, the electronic device may further include at least one hardware for the main function. The method may include turning on the at least one hardware using power provided from the distribution circuit.

According to an example embodiment, the method of operating the electronic device may include establishing a communication connection with the external electronic device through the communication circuit or another communication circuit included in the electronic device.

According to an example embodiment, the electronic device may further include at least one hardware for the main function. The method of operating the electronic device may further include controlling the at least one hardware to be turned on, based on a communication signal, which causes the at least one hardware to be turned on, being received through the communication connection.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that the various example embodiments and the terms used therein are not intended to limit the technological features set forth herein to particular embodiments and the disclosure includes various changes, equivalents, and/or alternatives for a corresponding embodiment With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an clement (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in embodiments of the disclosure, the term “module” may include a unit implemented in hardware, software, or firmware, or any combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Embodiments of the disclosure may be implemented as software (e.g., a program) including one or more instructions that are stored in a storage medium (e.g., an internal memory or external memory) that is readable by a machine (e.g., the electronic device 101). For example, a processor of the machine (e.g., the electronic device 101) may invoke at least one of the one or more instructions stored in the storage medium, and execute it. This allows the machine to be operated to perform at least one function according to the at least one instruction invoked. The one or more instructions each may include a code generated by a compiler or a code executable by an interpreter. The machine-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a battery;
a terminal configured to be connected to a wall power source;
a conversion circuit configured to convert alternating current power, provided from the wall power source through the terminal, into direct current power;
a distribution circuit configured to distribute the direct current power;
a controller, comprising circuitry, connected to the distribution circuit; and
a communication circuit configured to operate using power provided from the battery,
wherein the communication circuit is configured to:
periodically broadcast a beacon signal using the power provided from the battery in a state in which a main function of the electronic device is turned off, wherein the electronic device does not receive the alternating current power from the wall power source through the terminal and power is not provided to the conversion circuit, the distribution circuit, and the controller in the state in which the main function of the electronic device is turned off; and
provide a signal configured to cause the conversion circuit to be turned on to the conversion circuit, based on a response signal corresponding to the beacon signal being received from an external electronic device.

2. The electronic device of claim 1, further comprising a power supply configured to provide power to the conversion circuit using the power from the battery,
wherein the conversion circuit is configured to be turned on using the power from the power supply, based on the signal configured to cause the conversion circuit to be turned on being received from the communication circuit, so as to convert the alternating current power from the wall power source into the direct current power and provide the direct current power to the distribution circuit.

3. The electronic device of claim 2, further comprising at least one hardware for the main function,
wherein the at least one hardware is turned on using power provided from the distribution circuit.

4. The electronic device of claim 2, wherein the controller is configured to be turned on based on power provided from the distribution circuit, and
to establish a communication connection with the external electronic device through the communication circuit or another communication circuit included in the electronic device.

5. The electronic device of claim 4, further comprising at least one hardware for the main function,
wherein the controller is configured to control the at least one hardware to be turned on, based on a communication signal configured to cause the at least one hardware to be turned on being received through the communication connection.

6. The electronic device of claim 1, wherein the battery is configured to be charged using at least a part of the direct current power provided from the conversion circuit.

7. The electronic device of claim 1, wherein the communication circuit is configured to enter an inactive state after providing the signal configured to cause conversion circuit to be turned on to the conversion circuit.

8. The electronic device of claim 7, wherein the controller is configured to turn off the conversion circuit and/or the controller and activate the communication circuit, based on an event for turning off the electronic device being identified.

9. The electronic device claim 1, wherein the communication circuit is configured to provide the signal configured to cause the conversion circuit to be turned on to the conversion circuit, based on information included in the response signal satisfying a specified condition.

10. A method of operating an electronic device comprising a battery, a terminal configured to be connected to a wall power source, a conversion circuit configured to convert alternating current power, provided from the wall power source through the terminal, into direct current power, a distribution circuit configured to distribute the direct current power, a controller connected to the distribution circuit, and a communication circuit configured to operate using power provided from the battery, the method comprising:
periodically broadcasting a beacon signal using the power provided from the battery in a state in which a main function of the electronic device is turned off, wherein the electronic device does not receive the alternating current power from the wall power source through the terminal and power is not provided to the conversion circuit, the distribution circuit, and the controller in the state in which the main function of the electronic device (700) is turned off; and
providing a signal configured to cause the conversion circuit to be turned on to the conversion circuit, based on a response signal corresponding to the beacon signal being received from an external electronic device.

11. The method of claim 10, wherein the electronic device further comprises at least one hardware for the main function, and
wherein the method comprises turning on the at least one hardware using power provided from the distribution circuit.

12. The method of claim 10, comprising establishing a communication connection with the external electronic device through the communication circuit or another communication circuit included in the electronic device.

13. The method of claim 12, wherein the electronic device further comprises at least one hardware for the main function, and
wherein the method further comprises turning on the at least one hardware, based on a communication signal configured to cause the at least one hardware to be turned on being received through the communication connection.

14. An electronic device comprising:
a battery;
a first terminal configured to be connected to a wall power source;
a second terminal configured to be connected to a home appliance;
a conversion circuit configured to convert alternating current power provided from the wall power source through the first terminal, into direct current power and provide the direct current power through the second terminal;
a power supply configured to provide power for the operation of the conversion circuit using power provided from the battery; and
a communication circuit configured to operate using the power provided from the battery,
wherein the communication circuit is configured to:
periodically broadcast a beacon signal using the power provided from the battery in a state in which the conversion circuit is turned off, wherein, in the state in which the conversion circuit is turned off, the electronic device does not receive the alternating current power from the wall power source through the first terminal, and the direct current power is not provided to the home appliance through the second terminal; and
provide a signal that causes the conversion circuit to be turned on to the conversion circuit, based on a response signal to the beacon signal being received from an external electronic device.

15. The electronic device of claim 14, wherein the conversion circuit is configured to be turned on using power provided from the power supply, based on a signal, causing the communication circuit to be turned on, being received and configured to convert the alternating current power from the wall power source into the direct current power and provide the direct current power to the home appliance through the second terminal.

16. The electronic device of claim 14, wherein the battery is configured to be charged using at least some of the direct current power provided from the conversion circuit.

17. The electronic device of claim 14, wherein the communication circuit is configured to enter an inactive state after providing the signal causing turning on to the conversion circuit.

18. The electronic device of claim 14, wherein the communication circuit is configured to provide a signal causing the conversion circuit to be turned off to the conversion circuit, based on the home appliance being turned off after providing the signal causing the turning on to the conversion circuit.

19. The electronic device of claim 18, wherein the communication circuit is configured to identify whether the home appliance is turned off, based on a communication signal, configured to cause the home appliance to be turned off, being received from the external electronic device and/or a change in the magnitude of power output through the second terminal.

20. The electronic device of claim 14, wherein the communication circuit is configured to provide the signal causing the conversion circuit to be turned on to the conversion circuit, based on information included in the response signal satisfying a specified condition.
